(19) United States
(12) Patent Application Publication
(10) Pub. No.: US 2025/0232704 A1
(43) Pub. Date: Jul. 17, 2025

(54) DISPLAY DEVICE AND METHOD OF DRIVING THE SAME

(71) Applicant: Samsung Display Co., LTD., Yongin-si (KR)

(72) Inventors: Chul SHIN, Yongin-si (KR); Tae Wan KIM, Yongin-si (KR); Won Jin SEO, Yongin-si (KR); Jeong Ah LEE, Yongin-si (KR); Heung Sik TAE, Yongin-si (KR); Dae Ho HWANG, Yongin-si (KR)

(21) Appl. No.: 18/929,388

(22) Filed: Oct. 28, 2024

(30) Foreign Application Priority Data
Jan. 17, 2024 (KR) 10-2024-0007433

(51) Int. Cl. G09G 3/20

(52) U.S. Cl. CPC G09G 3/2077; G09G 2320/0233; G09G 2320/0257; G09G 2320/041; G09G 2320/045; G09G 2330/045; G09G 2340/125

(57) ABSTRACT

A display device includes: a display panel including pixels; and a display panel driver configured to drive the display panel, wherein the display panel driver is configured to determine a compensation frame in a compensation frame mode, and to display a compensation grayscale on a portion of the display panel in the compensation frame.

### CROSS-REFERENCE TO RELATED APPLICATION

The present application claims priority to and the benefit of Korean Patent Application No. 10-2024-0007433, filed on Jan. 17, 2024, in the Korean Intellectual Property Office, the entire disclosure of which is incorporated herein by reference.

### BACKGROUND

### 1. Technical Field

Aspects of some embodiments of the present disclosure generally relate to a display device and a method of driving the same.

### 2. Description of the Related Art

In general, a display device includes a display panel, a gate driver, a data driver, and a driving controller. The display panel includes a plurality of gate lines, a plurality of data lines, and a plurality of pixels electrically connected to the plurality of gate lines and the plurality of data lines. The gate driver provides gate signals to the gate lines, the data driver provides data voltages to the data lines, and the driving controller controls the gate driver and the data driver.

The display deice may display an image in a frame unit. There may be a problem, however, in that an image of a previous frame may remain as an afterimage. In addition, degradation of the display panel may more rapidly progress in an area in which the afterimage remains.

The above information disclosed in this Background section is only for enhancement of understanding of the background and therefore the information discussed in this Background section does not necessarily constitute prior art.

### SUMMARY

Aspects of some embodiments include a display device that may be capable of relatively reducing degradation caused by an afterimage.

Aspects of some embodiments may further include a method of driving a display device, in which the display device is driven.

According to some embodiments of the present disclosure, a display device includes: a display panel including pixels; and a display panel driver configured to drive the display panel, wherein the display panel driver determines a compensation frame in a compensation frame mode, and displays a compensation grayscale on a portion of the display panel in the compensation frame.

According to some embodiments, the compensation frame may be repeated K times.

According to some embodiments, the display device may further include a temperature sensor configured to measure a peripheral temperature of the display panel. According to some embodiments, the display panel driver may determine a predicted temperature of the display panel, based on the peripheral temperature, for each measurement cycle. According to some embodiments, a time when the compensation frame is repeated a maximum number of times may be shorter than or equal to the measurement cycle.

According to some embodiments, the display device may further include a temperature sensor configured to measure a peripheral temperature of the display panel. According to some embodiments, the display panel driver may determine a predicted temperature of the display panel, based on the peripheral temperature. According to some embodiments, a number of times the compensation frame is repeated may become larger as the predicted temperature of the portion of the display panel becomes higher.

According to some embodiments, the display device may further include a temperature sensor configured to measure a peripheral temperature of the display panel. According to some embodiments, the display panel driver may determine a predicted temperature of the display panel, based on the peripheral temperature. According to some embodiments, the display panel driver may operate in the compensation frame mode when the display panel includes a portion at which the predicted temperature is a reference temperature or higher.

According to some embodiments, the display panel driver the display panel driver may operate in the compensation frame mode when the display panel includes a portion at which an accumulated degradation amount is a reference degradation amount or more.

According to some embodiments, the compensation frame may be repeated K times. According to some embodiments, a number of times the compensation frame is repeated may become larger as an accumulated degradation amount of the portion of the display panel becomes larger.

According to some embodiments, the display panel driver may operate in the compensation frame mode from a next frame when the display panel includes a portion at which a load of a current frame is a reference load or more.

According to some embodiments, the compensation frame may be repeated K times. According to some embodiments, a number of times the compensation frame is repeated may become larger as a load of the portion of the display panel becomes larger.

According to some embodiments, the compensation frame mode may include first and second modes. According to some embodiments, the first and second modes may fixedly display the compensation grayscale in different areas.

According to some embodiments, in the compensation frame mode, the display panel driver may operate in one of the first and second modes, which is set by a user.

According to some embodiments, in the compensation frame mode, the display panel driver may select one of the first and second modes according to a kind of image displayed on the display panel.

According to some embodiments, the compensation grayscale may be a minimum grayscale.

According to some embodiments, the display device may further include a temperature sensor configured to measure a peripheral temperature of the display panel. According to some embodiments, the display panel driver may determine a predicted temperature of the display panel, based on the peripheral temperature, for each measurement cycle. According to some embodiments, the compensation grayscale may become smaller as the predicted temperature of the portion of the display panel becomes higher.

According to some embodiments, the compensation grayscale may become smaller as an accumulated degradation amount of the portion of the display panel becomes larger.

According to some embodiments, the compensation grayscale may become smaller as a load of the portion of the display panel becomes larger.

According to some embodiments, the display panel may include a display area in which an image is displayed. According to some embodiments, in the compensation frame, the display area may include a first area in which the compensation grayscale is displayed and a second area except the first area. According to some embodiments, the compensation grayscale may become smaller as becoming more distant from the second area.

According to some embodiments of the present disclosure, in a method of driving a display device, the method includes: determining an operation mode; determining a compensation frame in a compensation frame mode; and displaying a compensation grayscale on a portion of a display panel in the compensation frame.

According to some embodiments, the compensation frame may be repeated K times.

According to some embodiments, the method may further include determining a predicted temperature of the display panel, based on a peripheral temperature of the display panel, which is measured by a temperature sensor for each measurement cycle. According to some embodiments, a time when the compensation frame is repeated a maximum number of times may be shorter than or equal to the measurement cycle.

### BRIEF DESCRIPTION OF THE DRAWINGS

Aspects of some embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a block diagram illustrating a display device according to some embodiments of the present disclosure.

FIG. 2 is a diagram illustrating an example in which the display device shown in FIG. 1 operates in a normal mode.

FIG. 3 is a diagram illustrating an example in which the display device shown in FIG. 1 operates in a compensation frame mode.

FIGS. 4 to 6 are diagrams illustrating an example of a compensation grayscale of the display device shown in FIG. 1.

FIGS. 7 to 9 are block diagrams illustrating an example of a driving controller of the display device shown in FIG. 1.

FIG. 10 is a diagram illustrating an example of a number of times the display device shown in FIG. 1 repeats a compensation frame BF.

FIG. 11 is a diagram illustrating a compensation frame mode of a display device according to some embodiments of the present disclosure.

FIG. 12 is a flowchart illustrating a method of driving a display device according to some embodiments of the present disclosure.

FIG. 13 is a block diagram illustrating an electronic device according to some embodiments of the present disclosure.

FIG. 14 is a diagram illustrating an example in which the electronic device shown in FIG. 13 is implemented as a television.

### DETAILED DESCRIPTION

Hereinafter, aspects of some embodiments of the present disclosure will be described in more detail with reference to the accompanying drawings. In the description below, only a necessary part to understand an operation according to the present disclosure is described and the descriptions of other parts are omitted in order not to unnecessarily obscure subject matters of the present disclosure. In addition, the present disclosure is not limited to embodiments described herein, but may be embodied in various different forms. Rather, embodiments described herein are provided to more thoroughly and more completely describe the disclosed contents and to sufficiently transfer the ideas of the disclosure to a person of ordinary skill in the art.

In the entire specification, when an element is referred to as being “connected” or “coupled” to another element, it can be directly connected or coupled to the another element or be indirectly connected or coupled to the another element with one or more intervening elements interposed therebetween. The technical terms used herein are used only for the purpose of illustrating a specific embodiment and not intended to limit the embodiment. It will be understood that when a component “includes” an element, unless there is another opposite description thereto, it should be understood that the component does not exclude another element but may further include another element. It will be understood that for the purposes of this disclosure, “at least one of X, Y, and Z” can be construed as X only, Y only, Z only, or any combination of two or more items X, Y, and Z (e.g., XYZ, XYY, YZ, ZZ). Similarly, for the purposes of this disclosure, “at least one selected from the group consisting of X, Y, and Z” can be construed as X only, Y only, Z only, or any combination of two or more items X, Y, and Z (e.g., XYZ, XYY, YZ, ZZ).

It will be understood that, although the terms “first”, “second,” etc. may be used herein to describe various elements, these elements should not be limited by these terms. These terms are only used to distinguish one element from another element. Thus, a “first” element discussed below could also be termed a “second” element without departing from the teachings of the present disclosure.

Spatially relative terms, such as “below,” “above,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the term, “above,” may encompass both an orientation of above and below. The apparatus may be otherwise oriented (e.g., rotated 90 degrees or at other orientations) and the spatially relative descriptors used herein interpreted accordingly.

In addition, the embodiments of the disclosure are described here with reference to schematic diagrams of ideal embodiments (and an intermediate structure) of the present disclosure, so that changes in a shape as shown due to, for example, manufacturing technology and/or a tolerance may be expected. Therefore, the embodiments of the present disclosure shall not be limited to the specific shapes of a region shown here, but include shape deviations caused by, for example, the manufacturing technology. The regions shown in the drawings are schematic in nature, and the shapes thereof do not represent the actual shapes of the regions of the device, and do not limit the scope of the disclosure.

Hereinafter, aspects of some embodiments of the present disclosure will be described in more detail with reference to the accompanying drawings.

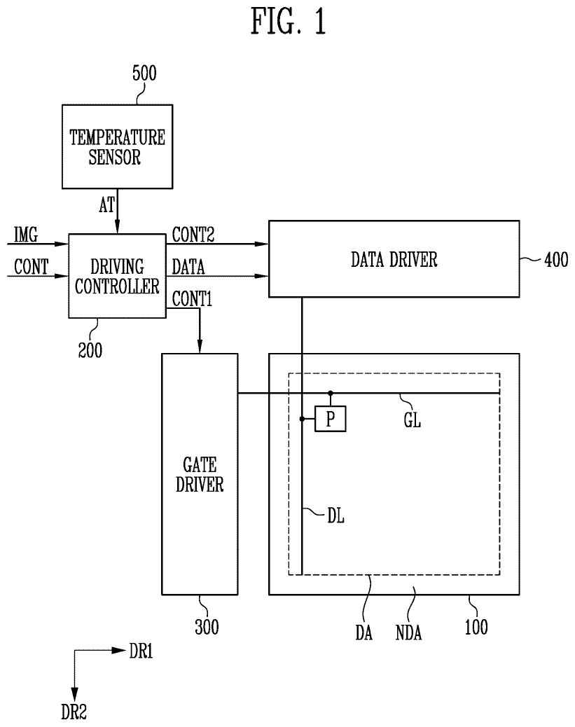

FIG. 1 is a block diagram illustrating a display device according to some embodiments of the present disclosure.

Referring to FIG. 1, the display device may include a display panel 100, a display panel driver, and a temperature sensor 500. The display panel driver may include a driving controller 200, a gate driver 300, and a data driver 400. According to some embodiments, the driving controller 200 and the data driver 400 may be integrated into one chip.

The display panel 100 may include a display area DA in which images are displayed and a non-display area NDA located adjacent to (e.g., in a periphery or outside a footprint of) the display area DA at which images are not displayed.

The display panel 100 may include a plurality of gate lines GL, a plurality of data lines DL, and a plurality of pixels P electrically connected to the gate lines GL and the data lines DL. The gate lines GL may extend in a first direction DR1, and the data lines DL may extend in a second direction DR2 intersecting the first direction DR1. Although FIG. 1 illustrates the display panel 100 including a single pixel P, a single gate line GL, and a single data line DL, as a person having ordinary skill in the art would recognize, embodiments according to the present disclosure are not limited thereto, and the number of pixels P, gate lines GL, and data lines DL may vary according to the size and function of the display panel 100.

The driving controller 200 may receive input image data IMG and an input control signal CONT from a main processor (e.g., a graphic processing unit (GPU) or the like). For example, the input image data IMG may include red image data, green image data, and blue image data. According to some embodiments, the input image data IMG may further include white image data. According to some embodiments, the input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 200 may generate a first control signal CONT1, a second control signal CONT2, and a data signal DATA, based on the input image data IMG and the input control signal CONT.

The driving controller 200 may generate the first control signal CONT1 for controlling an operation of the gate driver 300, based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 400, based on the input control signal CONT, and output the second control signal CONT2 to the data driver 400. The second control signal CONT2 may include a horizontal start signal and a load signal.

The driving controller 200 may generate the data signal DATA by receiving the input image data IMG and the input control signal CONT. The driving controller 200 may output the data signal DATA to the data driver 400.

The gate driver 300 may generate gate signals for driving the gate lines GL in response to the first control signal CONT1 input from the driving controller 200. The gate driver 300 may output the gate signals to the gate lines GL. For example, the gate driver 300 may sequentially output the gate signals to the gate lines GL.

The data driver 400 may receive the second control signal CONT2 and the data signal DATA, which are input from the driving controller 200. The data driver 400 may generate data voltages obtained by converting the data signal DATA into a voltage in an analog form. The data driver 400 may output the data voltages to the data lines DL.

The temperature sensor 500 may measure a peripheral temperature AT of the display panel 100 and provide the peripheral temperature AT to the driving controller 200. The driving controller 200 may receive the peripheral temperature AT input from the temperature sensor 500 to determine a predicted temperature of the display panel 100. This will be described in more detail later.

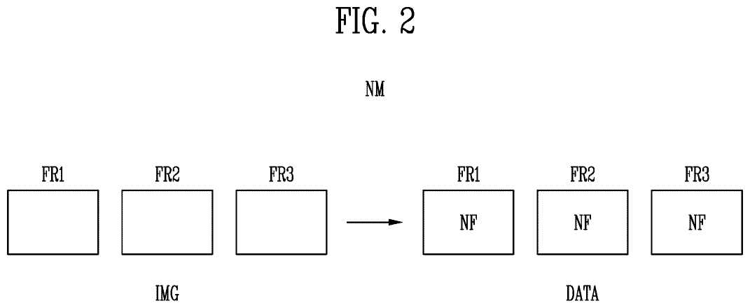

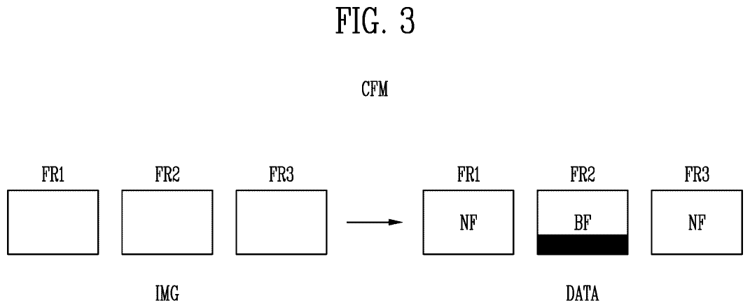

FIG. 2 is a diagram illustrating an example in which the display device shown in FIG. 1 operates in a normal mode. FIG. 3 is a diagram illustrating an example in which the display device shown in FIG. 1 operates in a compensation frame mode.

Referring to FIGS. 1 to 3, the driving controller 200 may operate in a normal mode NM or a compensation frame mode CFM.

In the normal mode NM, the driving controller 200 may display a normal frame NF on the display panel 100 (e.g., the display area DA). In the compensation frame mode CFM, the driving controller 200 may display a compensation frame in which a compensation grayscale is displayed on a portion of the display panel 100 (e.g., the display area DA) between normal frames NF.

The compensation frame BF is a frame in which a compensation grayscale is displayed in a partial area so as to prevent or reduce an afterimage and/or degradation caused by the afterimage. The normal frame NF is a frame in which any compensation grayscale is not displayed, and is a frame except (e.g., not including) the compensation frame BF. For example, a data signal DATA in the normal frame NF may include a grayscale corresponding to input image data IMG, and a data signal DATA in the compensation frame BF may include a compensation grayscale instead of a grayscale corresponding to the input image data IMG with respect to a partial area.

For example, in the normal mode NM, when input image data IMG including first to third frames FR1 to FR3 is input to the driving controller 200, the driving controller 200 may generate data signal DATA including each of the first to third frames FR1 to FR3 as a normal frame NF.

For example, in the compensation frame mode CFM, when input image data IMG including first to third frames FR1 to FR3 is input to the driving controller 200, the driving controller 200 may generate a data signal DATA which includes each of the first and third frames FR1 and FR3 as a normal frame NF and includes the second frame FR2 as a compensation frame BF.

In FIG. 3, for convenience of description, it is illustrated that the compensation grayscale is a minimum grayscale (i.e., a black grayscale) and is located at a lower end in the compensation frame BF, and one compensation frame BF is located between normal frames NF. However, embodiments according to the present disclosure are not limited thereto. This will be described in more detail later.

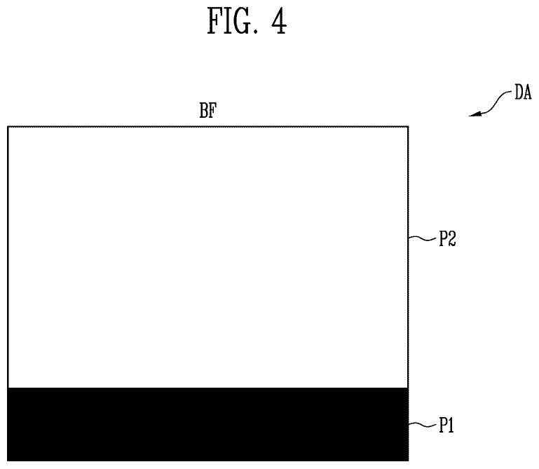

FIGS. 4 to 6 are diagrams illustrating an example of the compensation grayscale of the display device shown in FIG. 1.

Referring to FIGS. 4 to 6, in the compensation frame BF, the display area DA may include a first area P1 in which a compensation grayscale is displayed and a second area P2 except the first area P1.

Referring to FIG. 4, the compensation grayscale may be a minimum grayscale. For example, the compensation grayscale may be a black grayscale. The minimum grayscale is used as the compensation grayscale, so that an afterimage in the first area P1 and/or degradation caused by the afterimage can be relatively reduced.

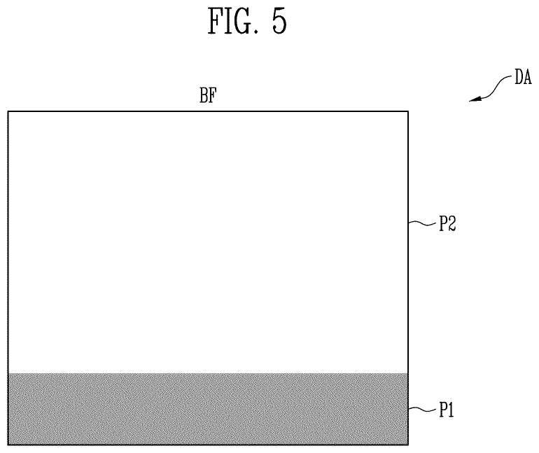

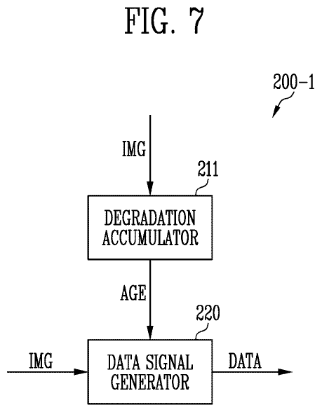

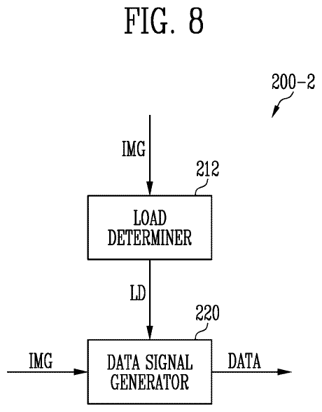

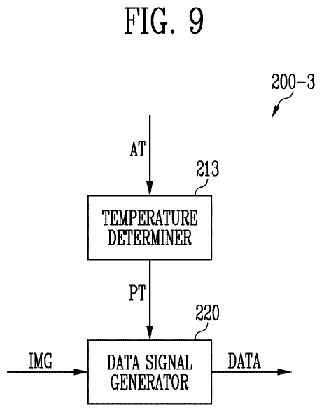

Referring to FIG. 5, the compensation grayscale may be determined based on at least one of an accumulated degradation amount AGE (see FIG. 7), a load LD (see FIG. 8), and a predicted temperature PT (see FIG. 9), which will be described later.

According to some embodiments, the compensation grayscale may become smaller as an accumulated degradation amount AGE (see FIG. 7) of the first area P1 becomes larger. For example, as an accumulated degradation amount AGE (see FIG. 7) of the first area P1 of a current frame becomes larger, a compensation grayscale of a compensation frame BF subsequent to the current frame may become smaller.

That is, it may be desirable that degradation caused by an afterimage be further relatively reduced as the accumulated degradation amount AGE (see FIG. 7) becomes larger. Therefore, the compensation grayscale may be determined according to the accumulated degradation amount AGE (see FIG. 7).

The accumulated degradation amount AGE (see FIG. 7) will be described in more detail later with reference to FIG. 7.

According to some embodiments, the compensation grayscale may become smaller as a load LD (see FIG. 8) of the first area P1 becomes larger. For example, as a load LD (see FIG. 8) of the first area P1 of a current frame becomes larger, a compensation grayscale of a compensation frame BF subsequent to the current frame may become smaller.

That is, it may be desirable that degradation caused by an afterimage should be further relatively reduced as the load LD (see FIG. 8) becomes larger. Therefore, the compensation grayscale may be determined according to the load LD (see FIG. 8).

The load LD (see FIG. 8) will be described in more detail later with reference to FIG. 8.

According to some embodiments, the compensation grayscale may become smaller as a predicted temperature PT (see FIG. 9) of the first area P1 becomes larger. For example, as a predicted temperature PT (see FIG. 9) of the first area P1 of a current frame becomes larger, a compensation grayscale of a compensation frame BF subsequent to the current frame may become smaller.

That is, it may be desirable that degradation caused by an afterimage should be further relatively reduced as the predicted temperature PT (see FIG. 9) becomes larger. Therefore, the compensation grayscale may be determined according to the predicted temperature PT (see FIG. 9).

The predicted temperature PT (see FIG. 9) will be described in more detail later with reference to FIG. 9.

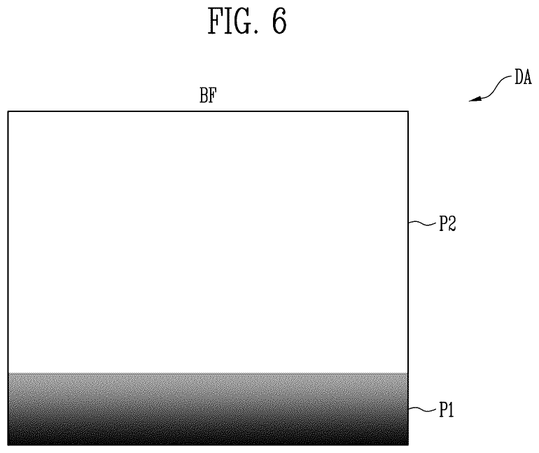

Referring to FIG. 6, the compensation grayscale may become smaller as becoming more distant from the second area P2. When the compensation grayscale is collectively displayed in the first area P1, a boundary line between the first area P1 and the second area P2 may be viewed (e.g., is visible to users). Accordingly, the compensation grayscale may be differently determined in the first area P1 such that the boundary line is not viewed (e.g., is not visible to users).

FIGS. 7 to 9 are block diagrams illustrating an example of the driving controller of the display device shown in FIG. 1.

FIGS. 7 to 9 illustrate that each of driving controllers 200-1 to 200-3 includes one of a degradation accumulator 211, a load determiner 212, and a temperature determiner 213, but embodiments according to the present disclosure are not limited thereto. For example, each of the driving controllers 200-1 to 200-3 may include two or more of the degradation accumulator 211, the load determiner 212, and the temperature determiner 213.

Referring to FIGS. 3, 4, and 7, the driving controller 200-1 may include the degradation accumulator 211 and a data signal generator 220.

The degradation accumulator 211 may determine a degradation amount of the pixels P (see FIG. 1), corresponding to input image data IMG (or input grayscale), and determine an accumulated degradation amount AGE by accumulating the degradation amount. The degradation amount may be a larger value as the input grayscale becomes higher.

For example, the degradation accumulator 211 may receive an accumulated degradation amount AGE of a previous frame through a memory device, and determine an accumulated degradation amount AGE of a current frame by accumulating a degradation amount of the current frame in the accumulated degradation amount AGE of the previous frame. In addition, the accumulated degradation amount AGE of the previous frame may be updated as the accumulated degradation amount AGE of the current frame.

The degradation accumulator 211 may divide the display area DA into a plurality of blocks, and determine a degradation amount and an accumulated degradation amount AGE of each of the blocks.

The data signal generator 220 may generate a data signal DATA, based on the accumulated degradation amount AGE and the input image data IMG.

The data signal generator 220 may determine an operation mode, based on the accumulated degradation amount AGE, determine a compensation frame BF, based on the accumulated degradation amount AGE, and determine a first area P1 in which a compensation grayscale is displayed, based on the accumulated degradation amount AGE.

The data signal generator 220 may operate in the compensation frame mode CFM when the display area DA includes a portion at which the accumulated degradation AGE is a reference degradation amount or more. Also, when the data signal generator 220 operates in the compensation frame mode CFM, the data signal generator 220 may determine a just next frame as the compensation frame BF, and display the compensation grayscale in the portion at which the accumulated degradation amount AGE is the reference degradation amount or more in the compensation frame BF. The reference degradation amount may be a value (e.g., a set or predetermined value).

For example, when the display area DA includes a portion at which the accumulated degradation amount AGE is the reference degradation amount or more in an Nth (N is a positive integer) frame, the data signal generator 220 may operate in the compensation frame mode CFM from an (N+1)th frame, and the (N+1)th frame may become the compensation frame BF. Also, the data signal generator 220 may generate a data signal DATA such that, in the (N+1)th frame, the compensation grayscale is displayed in the portion (i.e., the first area P1) at which the accumulated degradation amount AGE is the reference degradation amount or more in the Nth frame.

According to some embodiments, the compensation frame BF may be repeated K (K is a positive integer) times. For example, when the compensation frame BF is repeated twice, and the data signal generator 220 operates in the compensation frame mode CFM from the (N+1)th frame, (N+1)th and (N+2)th frames may become the compensation frame BF.

According to some embodiments, a number of times the compensation frame BF is repeated may become larger, as the accumulated amount AGE of the portion (i.e., the first area P1) at which the accumulated degradation amount AGE is the reference degradation amount or more becomes larger. As the accumulated degradation amount AGE becomes larger, it may become more desirable to prevent or reduce degradation caused by an afterimage. Thus, the number of times the compensation frame BF is repeated is increased as the accumulated degradation amount AGE becomes larger, so that the degradation caused by the afterimage can be effectively prevented or reduced.

Referring to FIGS. 3, 4, and 8, the driving controller 200-2 may include the load determiner 212 and a data signal generator 220.

The load determiner 212 may determine a load LD of a current frame, corresponding to input image data IMG (or input grayscale). The load determiner 212 may divide the display area DA into a plurality of blocks, and determine a load LD of each of the blocks.

The load LD may be a larger value as the input grayscale becomes higher. For example, in the case of a full white image, the load LD may be 100%. In the case of a full black image, the load LD may be 0%.

The data signal generator 220 may generate a data signal DATA, based on the load LD and the input image data IMG.

The data signal generator 220 may determine an operation mode, based on the load LD, determine a compensation frame BF, based on the load LD, and determine a first area P1 in which a compensation grayscale is displayed, based on the load LD.

The data signal generator 220 may operate in the compensation frame mode CFM from a next frame when the display area DA includes a portion at which the load LD of the current frame is a reference load or more. Also, when the data signal generator 220 operates in the compensation frame mode CFM, the data signal generator 220 may determine the next frame as the compensation frame BF, and display the compensation grayscale in the portion at which the load LD is the reference load or more. The reference load may be a value (e.g., a set or predetermined value).

For example, when the display area DA includes a portion at which the load LD is the reference load or more in an Nth frame, the data signal generator 220 may operate in the compensation frame mode CFM from an (N+1)th frame, and the (N+1)th frame may become the compensation frame BF. Also, in the (N+1)th frame, the data signal generator 220 may generate a data signal DATA such that the compensation grayscale is displayed in an area (i.e., the first area P1) corresponding to the portion at which the load LD is the reference load or more in the Nth frame.

According to some embodiments, the compensation frame BF may be repeated K (K is a positive integer) times. For example, when the compensation frame BF is repeated twice, and the data signal generator 220 operates in the compensation frame mode CFM from the (N+1)th frame, (N+1)th and (N+2)th frames may become the compensation frame BF.

According to some embodiments, a number of times the compensation frame BF is repeated may become larger as a load LD of the area (i.e., the first area P1) corresponding to the portion at which the load LD is the reference load or more becomes larger. As the load LD becomes larger, it may become more desirable to prevent or reduce degradation caused by an afterimage. Thus, the number of times the compensation frame is repeated is increased as the load LD becomes larger, so that the degradation caused by the afterimage can be effectively prevented or reduced.

Referring to FIGS. 3, 4, and 9, the driving controller 200-3 may include the temperature determiner 213 and a data signal generator 220.

The temperature determiner 213 may calculate a predicted temperature PT of the display panel 100 (see FIG. 1) according to a peripheral temperature AT of the display panel 100 (see FIG. 1). According to some embodiments, the temperature determiner 213 may generate a predicted temperature PT, using a lookup-table in which a predicted temperature PT corresponding to the peripheral temperature AT is stored. However, this is merely illustrative, and the embodiments of the present disclosure are not limited thereto. For example, the temperature determiner 213 may generate the predicted temperature from the peripheral temperature AT, using a separate equation. According to some embodiments, the temperature determiner 213 may generate the peripheral temperature AT as the predicted temperature PT.

The data signal generator 220 may generate a data signal DATA, based on the predicted temperature PT and input image data IMG.

The data signal generator 220 may determine an operation mode, based on the predicted temperature, determine a compensation frame BF, based on the predicted temperature, and determine a first area P1 in which a compensation grayscale is displayed, based on the predicted temperature.

The data signal generator 220 may operate in the compensation frame mode CFM when the display area DA includes a portion at which the predicted temperature PT is a reference temperature or higher. Also, when the data signal generator 220 is operated in the compensation frame mode CFM, the data signal generator 220 may determine a just next frame as the compensation frame BF, and display the compensation grayscale in the portion at which the predicted temperature PT is the reference temperature or higher in the compensation frame BF. The reference temperature may be a value (e.g., a set or predetermined value).

For example, when the display area DA includes a portion at which the predicted temperature is the reference temperature or higher in an Nth frame, the data signal generator 220 may operate in the compensation frame mode CFM from an (N+1)th frame, and the (N+1)th frame may become the compensation frame BF. Also, in the (N+1)th frame, the data signal generator 220 may generate a data signal DATA such that the compensation grayscale is displayed in the portion (i.e., the first area P1) at which the predicted temperature PT is the reference temperature or higher in the Nth frame.

According to some embodiments, the compensation frame BF may be repeated K (K is a positive integer) times. For example, when the compensation frame BF is repeated twice, and the data signal generator 220 operates in the compensation frame mode CFM from the (N+1)th frame, (N+1)th and (N+2)th frames may become the compensation frame BF.

According to some embodiments, a number of times the compensation frame BF is repeated may become larger as a predicted temperature PT of the portion (i.e., the first area P1) at which the predicted temperature is the reference temperature or higher becomes higher. As the predicted temperature PT becomes higher, it may become more desirable to prevent or reduce degradation caused by an afterimage. Thus, the number of times the compensation frame is repeated is increased as the predicted temperature PT becomes higher, so that the degradation caused by the afterimage can be effectively prevented or reduced.

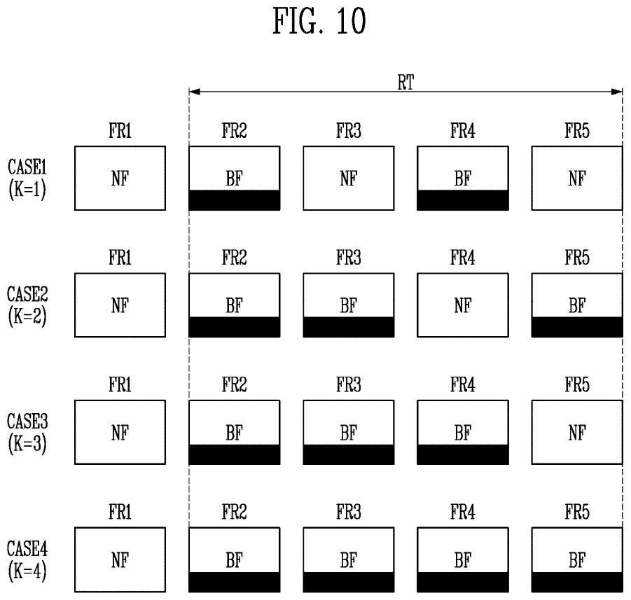

FIG. 10 is a diagram illustrating an example of a number of times the display device shown in FIG. 1 repeats the compensation frame BF.

Referring to FIGS. 1 and 10, the driving controller 200 may determine a predicted temperature PT (see FIG. 9) of the display panel 100, based on a peripheral temperature AT for each measurement cycle RT. The predicted temperature PT has been described with reference to FIG. 9, and therefore, some overlapping descriptions may be omitted.

The compensation frame BF may be repeated K times. A time when the compensation frame BF is repeated a maximum number of times may be shorter than or equal to the measurement cycle RT. For example, when the measurement cycle RT is equal to a time of four frames, K may be greater than or equal to 1 and be smaller than or equal to 4. That is, the driving controller 200 may arrange the compensation frame BF such that the temperature of the display panel 100 can be lowered before a next predicted temperature is measured.

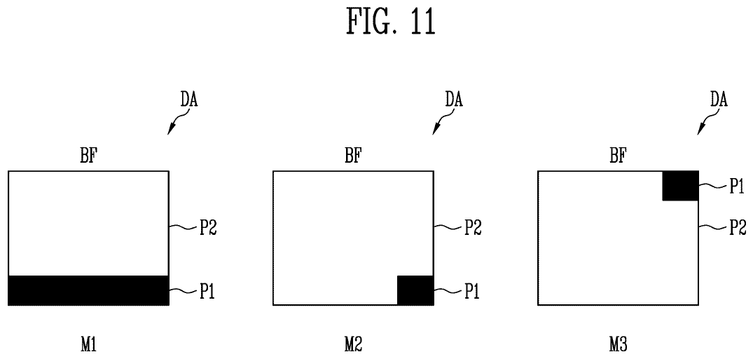

FIG. 11 is a diagram illustrating a compensation frame mode of a display device according to some embodiments of the present disclosure.

The display device according to some embodiments of the present disclosure is configured substantially identical to the display device shown in FIG. 1. Therefore, components identical or similar to those of the display device shown in FIG. 1 are designated by like reference numerals, and some overlapping descriptions may be omitted.

Referring to FIGS. 3 and 11, the compensation frame mode CFM may include first to third modes M1 to M3. The first to third modes M1 to M3 may fixedly display a compensation grayscale in different areas.

For example, in the first mode M1, a first area P1 may be located at a lower end in the compensation frame BF. For example, in the first mode M1, an image in which subtitles are displayed may be displayed in the compensation frame BF, and the first area P1 may be an area in which the subtitles are located.

For example, in the second mode M2, a first area P1 may be located at a right lower end in the compensation frame BF. For example, in the second mode M2, an image in which a logo is located may be displayed at the right lower end in the compensation frame BF, and the first area P1 may be an area in which the logo is located.

For example, in the third mode M3, a first area P1 may be located at a right upper end in the compensation frame BF. For example, in the third mode M3, an image in which a logo is located may be displayed at the right upper end in the compensation frame BF, and the first area P1 may be an area in which the logo is located.

In the compensation frame mode CFM, the driving controller 200 may operate in one set by a user among the first to third modes M1 to M3. That is, the first to third modes M1 to M3 may be modes set by the user to be suitable for attributes of an image.

In the compensation frame mode CFM, the driving controller 200 may select one of the first to third modes M1 to M3 according to a kind of image located in the display area DA. For example, the driving controller 200 may determine a kind of image, based on input image data, operate in the first mode M1 when the image is an image in which subtitles are located, operate in the second mode M2 when the image is an image in which a logo is located at a right lower end, and operate in the third mode M3 when the image is an image in which a logo is located at a right upper end.

In these embodiments, it is illustrated that the compensation frame mode CFM includes three modes. However, embodiments according to the present disclosure are not limited to the number of modes.

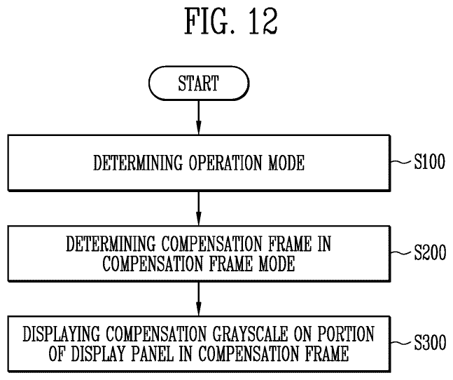

FIG. 12 is a flowchart illustrating a method of driving a display device according to some embodiments of the present disclosure. Although FIG. 12 illustrates various operations, a method of driving a display device is not limited thereto, and according to some embodiments, the method of driving a display device may include additional operations or fewer operations, or the order of operations may vary, unless otherwise stated or implied, without departing from the spirit and scope of embodiments according to the present disclosure.

Referring to FIG. 12, in the method of driving the display device, an operation mode may be determined (S100), a compensation frame may be determined in a compensation frame mode (S200), and the compensation grayscale may be displayed on a portion of a display panel in the compensation frame (S300).

The operation mode and the compensation frame have been described with reference to FIGS. 7 to 9, and the compensation grayscale has been described with reference to FIGS. 4 to 6. Therefore, some overlapping descriptions may be omitted.

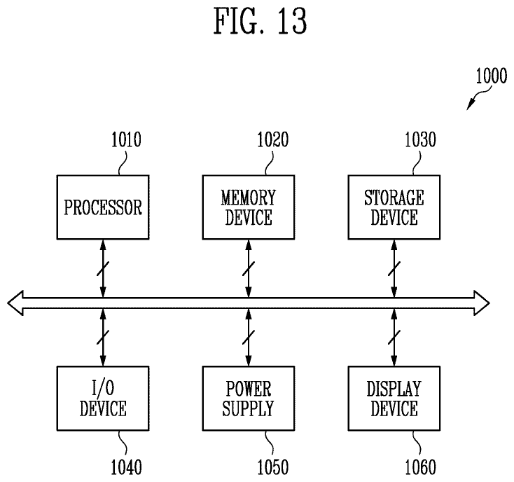

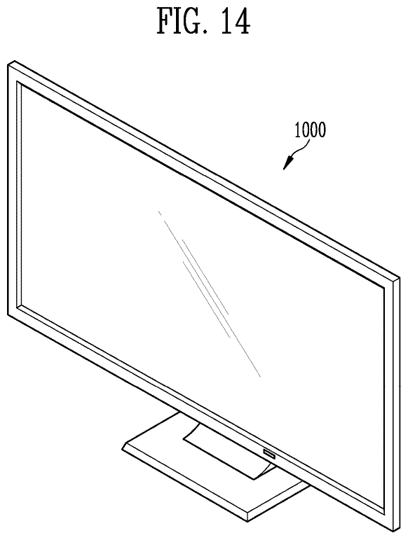

FIG. 13 is a block diagram illustrating an electronic device according to some embodiments of the present disclosure. FIG. 14 is a diagram illustrating an example in which the electronic device shown in FIG. 13 is implemented as a television.

Referring to FIGS. 12 and 13, the electronic device 1000 may include a processor 1010, a memory device 1020, a storage device 1030, an input/output (I/O) device 1040, a power supply, 1050, and a display device 1060. The display device 1060 may be the display device shown in FIG. 1. Also, the electronic device 1000 may further include several ports capable of communicating with a video card, a sound card, a memory card, a USB device, and the like, or communicating with other systems. According to some embodiments, as shown in FIG. 14, the electronic device 1000 may be implemented as a television. However, this is merely illustrative, and the electronic device 1000 is not limited thereto. For example, the electronic device 1000 may be implemented as a mobile phone, a video phone, a smart pad, a smart watch, a tablet PC, a vehicle navigation system, a computer monitor, a notebook computer, a head mounted display device, or the like.

The processor 1010 may perform specific calculations or tasks. In some embodiments, the processor 1010 may be a microprocessor, a central processing unit, an application processor, or the like. The processor 1010 may be connected to other components through an address bus, a control bus, a data bus, and the like. In some embodiments, the processor 1010 may be connected to an extension bus such as a peripheral component interconnect (PCI) bus.

The memory device 1020 may store data necessary for an operation of the electronic device 1000. For example, the memory device 1020 may include a nonvolatile memory device such as an Erasable Programmable Read-Only Memory (EPROM) device, an Electrically Erasable Programmable Read-Only Memory (EEPROM) device, a flash memory device, a Phase Change Random Access Memory (PRAM) device, a Resistance Random Access Memory (RRAM) device, a Nano Floating Gate Memory (NFGM) device, a Polymer Random Access Memory (PoRAM) device, a Magnetic Random Access Memory (MRAM) device, or a Ferroelectric Random Access Memory (FRAM) device, and/or a volatile memory device such as a Dynamic Random Access Memory (DRAM) device, a Static Random Access Memory (SRAM) device, or a mobile DRAM device.

The storage device 1030 may include a Solid State Drive (SSD), a Hard Disk Drive (HDD), a CD-ROM, and the like.

The I/O device 1040 may include an input means such as a keyboard, a keypad, a touch screen, or a mouse, and an output means such as a speaker or a printer. In some embodiments, the display device 1060 may be included in the I/O device 1040.

The power supply 1050 may supply power necessary for an operation of the electronic device 1000. For example, the power supply 1050 may be a power management integrated circuit (PMIC).

The display device 1060 may display an image corresponding to visual information of the electronic device 1000. The display device 1060 may be an organic light emitting display device or a quantum dot light emitting display device, but the present disclosure is not limited thereto. The display device 1060 may be connected to other components through the buses or another communication link.

The present disclosure can be applied to display devices and electronic devices including the same. For example, the present disclosure can be applied to digital TVs, 3D TVs, mobile phones, smart phones, tablet computers, VR devices, PCs, home appliances, notebook computers, PDAs, PMPs, digital cameras, music players, portable game consoles, navigation systems, and the like.

In the display device according to some embodiments of the present disclosure, a compensation grayscale may be displayed on a portion of the display panel, so that degradation caused by an afterimage can be relatively reduced.

In the display device according to some embodiments of the present disclosure, a compensation grayscale is displayed on a portion of the display panel, so that an afterimage at a specific position can be relatively reduced.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims, and their equivalents.

What is claimed is:

1. A display device comprising:
a display panel including pixels; and
a display panel driver configured to drive the display panel,
wherein the display panel driver is configured to determine a compensation frame in a compensation frame mode, and to display a compensation grayscale on a portion of the display panel in the compensation frame.

2. The display device of claim 1, wherein the compensation frame is repeated K times, and
wherein K is a positive integer.

3. The display device of claim 2, further comprising a temperature sensor configured to measure a peripheral temperature of the display panel,
wherein the display panel driver is configured to determine a predicted temperature of the display panel, based on the peripheral temperature, for each measurement cycle, and
wherein a time when the compensation frame is repeated a maximum number of times is shorter than or equal to the measurement cycle.

4. The display device of claim 2, further comprising a temperature sensor configured to measure a peripheral temperature of the display panel,
wherein the display panel driver is configured to determine a predicted temperature of the display panel, based on the peripheral temperature, and
wherein a number of times the compensation frame is repeated becomes larger as the predicted temperature of the portion of the display panel becomes higher.

5. The display device of claim 1, further comprising a temperature sensor configured to measure a peripheral temperature of the display panel,
wherein the display panel driver is configured to determine a predicted temperature of the display panel, based on the peripheral temperature, and
wherein the display panel driver is configured to operate in the compensation frame mode when the display panel includes a portion at which the predicted temperature is a reference temperature or higher.

6. The display device of claim 1, wherein the display panel driver is configured to operate in the compensation frame mode based on the display panel including a portion at which an accumulated degradation amount is a reference degradation amount or more.

7. The display device of claim 1, wherein the compensation frame is repeated K times,
wherein a number of times the compensation frame is repeated becomes larger as an accumulated degradation amount of the portion of the display panel becomes larger, and
wherein K is a positive integer.

8. The display device of claim 1, wherein the display panel driver is configured to operate in the compensation frame mode from a next frame based on the display panel including a portion at which a load of a current frame is a reference load or more.

9. The display device of claim 1, wherein the compensation frame is repeated K times,
wherein a number of times the compensation frame is repeated becomes larger as a load of the portion of the display panel becomes larger, and
wherein K is a positive integer.

10. The display device of claim 1, wherein the compensation frame mode includes first and second modes, and
wherein the first and second modes fixedly display the compensation grayscale in different areas.

11. The display device of claim 10, wherein, in the compensation frame mode, the display panel driver is configured to operate in one of the first and second modes, which is set by a user.

12. The display device of claim 10, wherein, in the compensation frame mode, the display panel driver is configured to select one of the first and second modes according to a kind of image on the display panel.

13. The display device of claim 1, wherein the compensation grayscale is a minimum grayscale.

14. The display device of claim 1, further comprising a temperature sensor configured to measure a peripheral temperature of the display panel,
wherein the display panel driver is configured to determine a predicted temperature of the display panel, based on the peripheral temperature, for each measurement cycle, and
wherein the compensation grayscale becomes smaller as the predicted temperature of the portion of the display panel becomes higher.

15. The display device of claim 1, wherein the compensation grayscale becomes smaller as an accumulated degradation amount of the portion of the display panel becomes larger.

16. The display device of claim 1, wherein the compensation grayscale becomes smaller as a load of the portion of the display panel becomes larger.

17. The display device of claim 1, wherein the display panel includes a display area in which an image is displayed,
wherein, in the compensation frame, the display area includes a first area in which the compensation grayscale is displayed and a second area except the first area, and
wherein the compensation grayscale becomes smaller as becoming more distant from the second area.

18. A method of driving a display device, the method comprising:
determining an operation mode;
determining a compensation frame in a compensation frame mode; and
displaying a compensation grayscale on a portion of a display panel in the compensation frame.

19. The method of claim 18, wherein the compensation frame is repeated K times, and
wherein K is a positive integer.

20. The method of claim 18, further comprising determining a predicted temperature of the display panel, based on a peripheral temperature of the display panel, which is measured by a temperature sensor for each measurement cycle,
wherein a time when the compensation frame is repeated a maximum number of times is shorter than or equal to the measurement cycle.
